(19) United States
(12) Patent Application Publication
(10) Pub. No.: US 2007/0075235 A1
(43) Pub. Date: Apr. 5, 2007

(54) Packaging structure of a light-sensing element with reduced packaging area

(76) Inventor: Po-Hung Chen, Shin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/239,027

(22) Filed: Sep. 30, 2005

(51) Int. Cl. H01J 40/14

(52) U.S. Cl. 250/239

(57) ABSTRACT

The present invention discloses a packaging structure of a light-sensing element with reduced packaging area, wherein the central line of the light-sensing element coincides with the central line of the substrate in order to save the area expended in the conventional technology owing to that the central line of the light-sensing region coincides with the central line of the substrate. Thereby, the overall packaging area is effectively reduced. Further, engagement portions are formed in appropriate positions, which can be used to position the lens base and the lens cone installed subsequently in order to align them to the central line of the light-sensing region.

### BACKGROUND OF THE INVENTION

1. Field of the Invention

The present invention relates to a packaging structure of a light-sensing element, particularly to a packaging structure of a light-sensing element with reduced packaging area.

2. Description of the Related Art

To fabricate slim, lightweight and portable electronic products has become a guiding principle of the enterprises. Such a principle also works in a light-sensing element since it is a member of electronic products; thus, there is also a demand for the light-sensing element to reduce the packaging area thereof.

Refer to FIG. 1 and FIG. 2 schematic diagrams showing the conventional packaging structures of a CMOS light-sensing element. In the conventional packaging structure, when the light-sensing element 10 is disposed on the substrate 12, the central line a-a′ of the light-sensing region 14 coincides with the central line of the substrate 12, i.e. the image is aligned to be at the center of the substrate 12 in the conventional packaging structure. However, owing to some factors of the fabrication process, the central line a-a′ of the light-sensing region 14 usually deviates from the central line b-b′ of the light-sensing element 10 by a displacement ΔL. Such a packaging structure, wherein the central line a-a′ of the light-sensing region 14 coincides with the central line of the substrate 12, brings about extra area expense, i.e. a length of 2×ΔL is extra wasted. In the current packaging structure, the width and length is of the same dimension; thus, the wasted area will amount to (2×ΔL)². It is obvious that the larger the spacing between the centers of the light-sensing region 14 and the light-sensing element 10, the greater the wasted area. In the conventional packaging structure, in order to avoid the directional problem in assembling the lens base and lens cone, the center of the lens cone is designed to aim at the center of the substrate 12. Thus, the assembled light-sensing module also confronts extra area waste resulting from the spacing between the centers of the light-sensing region 14 and the light-sensing element 10. Therefore, it is hard for the conventional structure to reduce its packaging area and volume.

Accordingly, the present invention proposes a packaging structure of a light-sensing element with reduced packaging area to solve the abovementioned problems.

### SUMMARY OF THE INVENTION

The primary objective of the present invention is to provide a packaging structure of a light-sensing element, wherein the packaging area is effectively reduced so that the product can be made slim and lightweight to meet the market demand and has higher competitiveness.

Another objective of the present invention is to provide a packaging structure of a light-sensing element, which can realize the reduction of the packaging area.

The present invention proposes a packaging structure of a light-sensing element with reduced packaging area, which comprising: a substrate, having metallization traces; a light-sensing element, installed on the substrate, and having a light-sensing region, wherein the central line of the light-sensing element coincides with the central line of the substrate; and a light-transparent layer, installed to the substrate, and covering the light-sensing element.

According to another embodiment, the packaging structure of a light-sensing element with reduced packaging area of the present invention comprises: a substrate, having metallization traces on its surface and an engagement portion on one side thereof; a light-sensing element, installed on the substrate, and having a light-sensing region, wherein the central line of the light-sensing element coincides with the central line of the substrate; a light-transparent layer, installed to a frame, and covering the light-sensing element; a lens cone, installed to the substrate and the light-transparent layer, and having a corresponding engagement portion, which mates with the engagement portion for positioning; and a lens base, installed to the lens cone, and having an open hole aimed at the center of the light-sensing region.

According to further embodiment, the packaging structure of a light-sensing element with reduced packaging area of the present invention, comprises: a substrate, having metallization traces on its surface; a light-sensing element, installed on the substrate, and having a light-sensing region, wherein the central line of the light-sensing element coincides with the central line of the substrate; a frame, installed to the substrate, and encircling the light-sensing element, and having an engagement portion on one side thereof; a light-transparent layer, installed to the frame, and covering the light-sensing element; a lens cone, installed to the frame and the light-transparent layer, having a corresponding engagement portion, which mates with the engagement portion for positioning; and a lens base, installed to the lens cone, and having an open hole aimed at the center of the light-sensing region.

To enable the objectives, technical contents, characteristics and accomplishments of the present invention to be more easily understood, the embodiments of the present invention are to be described below in detail in cooperation with the drawings.

### BRIEF DESCRIPTION OF THE DRAWINGS

FIG. 1 is a schematic diagram showing a conventional packaging structure of a light-sensing element.

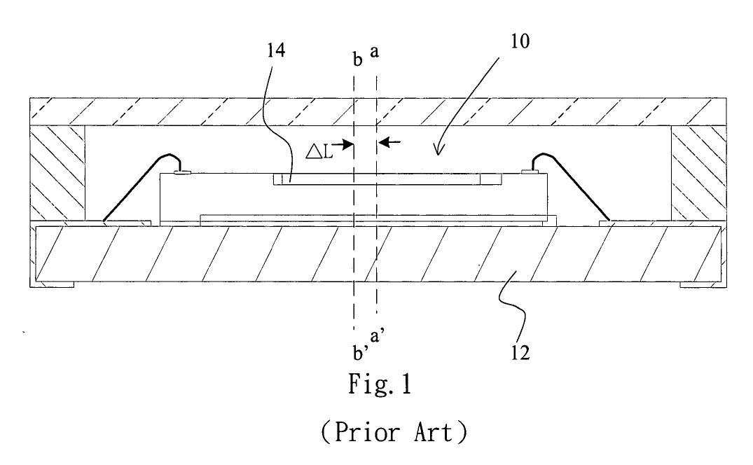

FIG. 2 is a schematic diagram showing another conventional packaging structure of a light-sensing element.

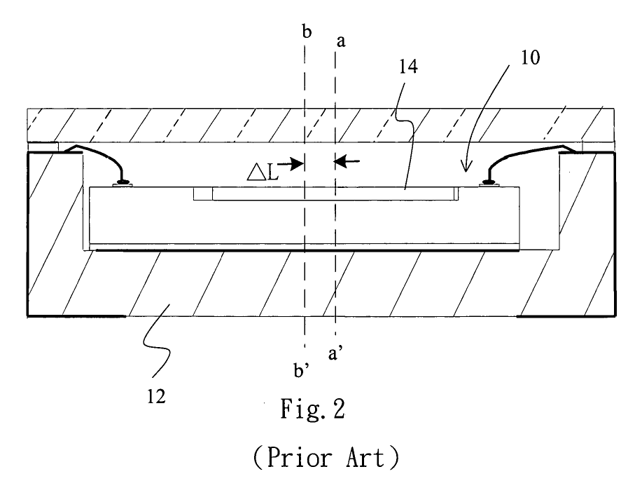

FIG. 3 is a schematic diagram showing one embodiment of the present invention.

FIG. 4 is a schematic diagram showing another embodiment of the present invention.

FIG. 5 is a schematic diagram showing further another embodiment of the present invention.

### DETAILED DESCRIPTION OF THE INVENTION

The present invention proposes a packaging structure of a light-sensing element with reduced packaging area, which can be used to fabricate slim, lightweight and portable electronic products.

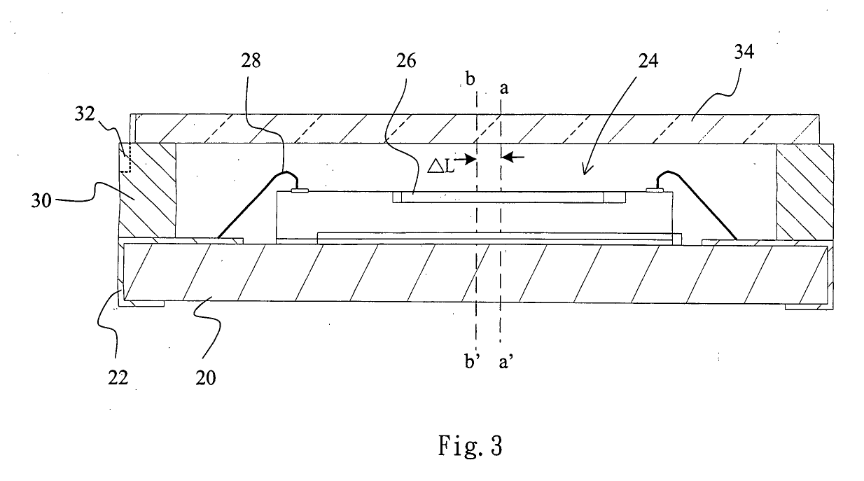

Refer to FIG. 3 a schematic diagram showing one embodiment of the present invention. As show in FIG. 3, the packaging structure of a light-sensing element with reduced packaging area of the present invention comprises: a substrate 20, square or rectangular, and having metallization traces 22 on appropriate positions, wherein in this embodiment, the metallization traces 22 extend from the top surface down to the bottom surface in order to electrically connect with a PCB (not shown in the drawing) afterward; a light-sensing element 24, installed on the substrate 20, and having a light-sensing region 26, wherein the central line b-b′ of the light-sensing element 24 coincides with the central line of the substrate 20 with a tolerance less than 0.5 mm, and the light-sensing element 24 is electrically connected to the substrate 20 via multiple bond wires 28; a frame 30, stuck to the substrate 20, and encircling the light-sensing element 24, and having an engagement portion 32 on its outer wall for positioning; and a light-transparent layer 34, stuck to the frame 30 with the engagement portion 32 revealed, wherein the light-transparent layer 34 is stuck to the frame 30 with a UV glue or a thermosetting glue, and the light-permeable layer 32 may be made of a transparent glass.

In this embodiment, the central line b-b′ of the light-sensing element 24 coincides with the central line of the substrate 20. Thus, the extra wasted area in the conventional technology, which results from that the central line a-a′ of the light-sensing region 26 coincides with the central line of the substrate 20, i.e. the image is aimed at the center of the substrate 20, can be avoided, and the overall packaging volume of the light-sensing element is effectively reduced so that the product can farther meet the current demand.

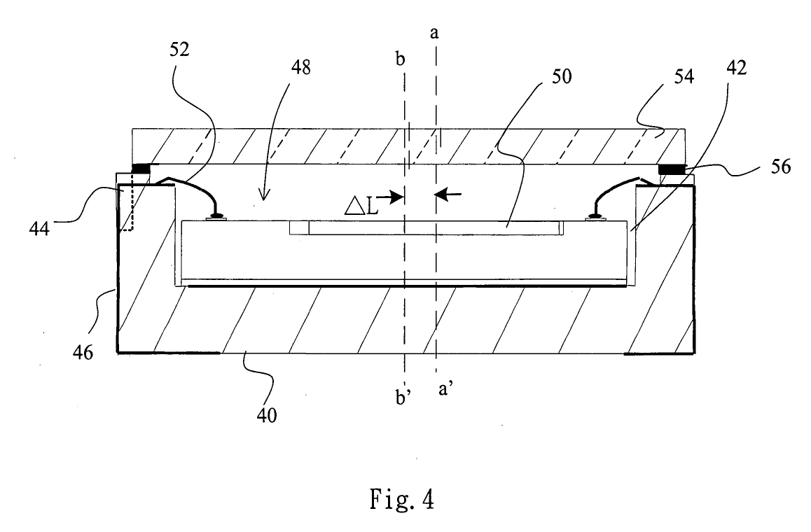

Refer to FIG. 4 a schematic diagram showing another embodiment of the present invention. In this embodiment, the substrate and the frame mentioned in the preceding embodiment are formed into a unitary body, and the sticking step thereof is thus omitted. As show in FIG. 4, the packaging structure of a light-sensing element with reduced packaging area of the present invention comprises: a substrate 40, having a basin 42 for containing a light-sensing element and protecting the light-sensing element from external particles and pollutants, and having an engagement portion 44 on its outer wall, and having metallization traces 46 at appropriate positions; a light-sensing element 48, disposed inside the basin 42, and having a light-sensing region 50, wherein the central line b-b′ of the light-sensing element 48 coincides with the central line of the substrate 40, and the light-sensing element 48 is electrically connected to the substrate 40 via multiple bond wires 52; and a light-transparent layer 54, stuck to the substrate 40 with the engagement portion 44 revealed, wherein the light-transparent layer 54 is stuck to the substrate 40 with a glue layer 56, and the glue layer 56 may be a UV glue or a thermosetting glue, and the light-permeable layer 54 may be made of a transparent glass.

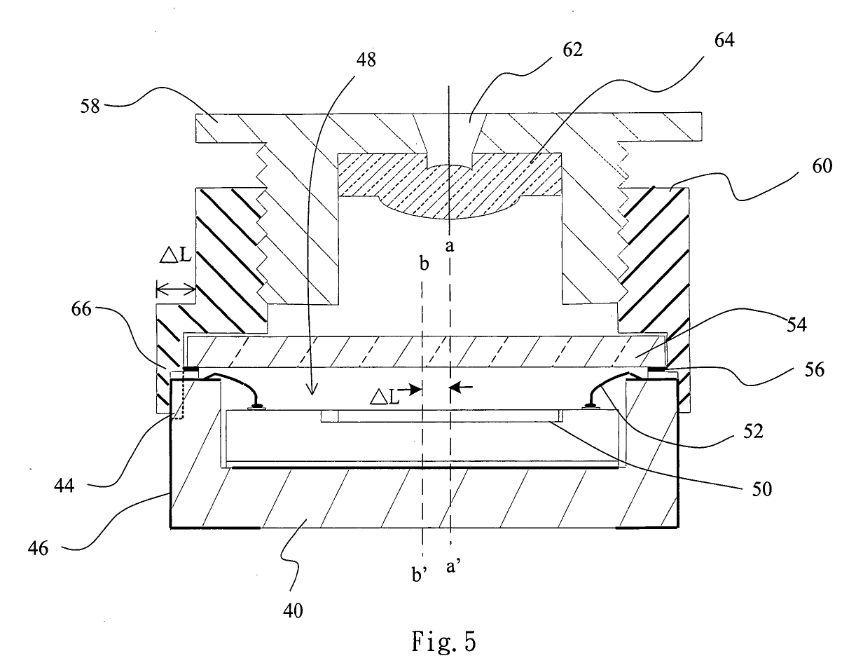

Refer to FIG. 5 a schematic diagram showing further another embodiment of the present invention wherein a lens base and a lens cone are installed to the packaging structure of the preceding embodiments, and the packaging structure in FIG. 4 is used for exemplification. As show in FIG. 5, a lens base 58 is fixed to a lens cone 60 beforehand, and then, the lens cone 60 together with the lens base 58 is installed to the substrate 40 and the light-transparent layer 54. The lens base 58 has optical designs, such as an open hole 62 and an aspherical lens 64. The lens cone 60 has a corresponding engagement portion 66, which is used to mate with the engagement portion 44 for positioning, so that the assemblage can be free from the directional problem. One side of the lens cone 60 has an appropriate displacement. As shown in FIG. 5, the center of the lens cone 60 is displaced toward the central line a-a′ of the image by a displacement AL so that the open hole 62 of the lens base 58 can be exactly aimed at the center of the image.

In contrast to the conventional packaging structure that the central line of the light-sensing region (the central line of the image) coincides with the central line of the substrate, the present invention is a packaging structure of a light-sensing element with reduced packaging area, wherein the central line of the light-sensing element coincides with the central line of the substrate. The extra wasted length of double the spacing between the central line of the light-sensing region and the central line of the light-sensing element in the conventional technology is overcome in the present invention, and the objective of reducing the overall packaging area is thus achieved. In the present invention, the engagement portions are used in assembling the lens cone to the substrate so that the assemblage can be performed correctly and free from the directional problem. Further, the center of the lens cone is displaced by a length equal to the spacing between the center of the light-sensing element and the center of the light-sensing region so that the open hole of the lens base can be exactly aimed at the center of the image. Thus, the extra volume wasted in the conventional technology is also overcome in the present invention.

Those described above are only the preferred embodiments of the present invention but not intended to limit the scope of the present invention. Any equivalent modification or variation according to the shape, structure, characteristics or spirit disclosed in the claims of the present invention is to be included within the scope of the present invention.

What is claimed is:

1. A packaging structure of a light-sensing element with reduced packaging area, comprising:
a substrate, having metallization traces on its surface;
a light-sensing element, installed on said substrate, and having a light-sensing region, wherein the central line of said light-sensing element coincides with the central line of said substrate; and
a light-transparent layer, installed to said substrate, and covering said light-sensing element.

2. The packaging structure of a light-sensing element with reduced packaging area according to claim 1, wherein said substrate has a basin for containing said light-sensing element.

3. The packaging structure of a light-sensing element with reduced packaging area according to claim 1, wherein said light-sensing element is electrically connected to said metallization traces via multiple bond wires.

4. The packaging structure of a light-sensing element with reduced packaging area according to claim 1, wherein at least one side of said substrate has an engagement portion.

5. The packaging structure of a light-sensing element with reduced packaging area according to claim 4, which further comprises:
a lens cone, installed to said substrate and said light-transparent layer, and having at least a corresponding engagement portion, which mates with said engagement portion; and
a lens base, installed to said lens cone, and having an open hole aimed at the center of said light-sensing region.

6. The packaging structure of a light-sensing element with reduced packaging area according to claim 5, wherein the center of said lens cone is displaced by a length equal to the spacing between the center of said light-sensing element and the center of said light-sensing region.

7. The packaging structure of a light-sensing element with reduced packaging area according to claim 1, wherein said light-transparent layer can filter out a light of a specific wavelength, such as a far infrared ray.

8. The packaging structure of a light-sensing element with reduced packaging area according to claim 1, wherein a frame encircling said light-sensing element is formed between said substrate and said light-transparent layer.

9. The packaging structure of a light-sensing element with reduced packaging area according to claim 8, wherein at least one side of said frame has an engagement portion.

10. The packaging structure of a light-sensing element with reduced packaging area according to claim 8, which further comprises:
a lens cone, installed to said frame and said light-transparent layer, and having at least a corresponding engagement portion, which mates with said engagement portion; and
a lens base, installed to said lens cone, and having an open hole aimed at the center of said light-sensing region.

11. A packaging structure of a light-sensing element with reduced packaging area, comprising:
a substrate, having metallization traces on its surface, wherein one side of said substrate has at least an engagement portion;
a light-sensing element, installed on said substrate, and having a light-sensing region, wherein the central line of said light-sensing element coincides with the central line of said substrate;
a light-transparent layer, installed to said substrate, and covering said light-sensing element;
a lens cone, installed to said substrate and said light-transparent layer, and having at lest a corresponding engagement portion, which mates with said engagement portion; and
a lens base, installed to said lens cone, and having an open hole aimed at the center of said light-sensing region.

12. The packaging structure of a light-sensing element with reduced packaging area according to claim 11, wherein said light-sensing element is electrically connected to said metallization traces via multiple bond wires.

13. The packaging structure of a light-sensing element with reduced packaging area according to claim 11, wherein said substrate has a basin for containing said light-sensing element.

14. The packaging structure of a light-sensing element with reduced packaging area according to claim 11, wherein the center of said lens cone is displaced by a length equal to the spacing between the center of said light-sensing element and the center of said light-sensing region.

15. The packaging structure of a light-sensing element with reduced packaging area according to claim 11, wherein said light-transparent layer is stuck to said substrate with a glue layer, and said glue layer may be a UV glue or a thermosetting glue.

16. A packaging structure of a light-sensing element with reduced packaging area, comprising:
a substrate, having metallization traces on its surface;
a light-sensing element, installed on said substrate, and having a light-sensing region, wherein the central line of said light-sensing element coincides with the central line of said substrate;
a frame, installed to said substrate, and encircling said light-sensing element, wherein one side of said frame has at least an engagement portion;
a light-transparent layer, installed to said frame, and covering said light-sensing element;
a lens cone, installed to said frame and said light-transparent layer, and having at least a corresponding engagement portion, which mates with said engagement portion; and
a lens base, installed to said lens cone, and having an open hole aimed at the center of said light-sensing region.

17. The packaging structure of a light-sensing element with reduced packaging area according to claim 16, wherein the center of said lens cone is displaced by a length equal to the spacing between the center of said light-sensing element and the center of said light-sensing region.

18. The packaging structure of a light-sensing element with reduced packaging area according to claim 16, wherein said substrate is square or rectangular.

19. The packaging structure of a light-sensing element with reduced packaging area according to claim 16, wherein said light-sensing element is electrically connected to said metallization traces via multiple bond wires.
